(19) United States
(12) Patent Application Publication
(10) Pub. No.: US 2017/0083775 A1
(43) Pub. Date: Mar. 23, 2017

(54) METHOD AND SYSTEM FOR PATTERN DETECTION, CLASSIFICATION AND TRACKING

(71) Applicant: BRIGHTWAY VISION LTD., Haifa (IL)

(72) Inventors: Yoav GRAUER, Haifa (IL); Ofer DAVID, Haifa (IL)

(21) Appl. No.: 15/311,855

(22) PCT Filed: Jun. 11, 2015
(86) PCT No.: PCT/IL2015/050595

§ 371 Date: Nov. 17, 2016

(30) Foreign Application Priority Data
Jun. 12, 2014 (IL) 233114

(51) Int. Cl. G06K 9/00; H04N 7/18; H04N 5/225; G06K 9/20; G06K 9/46

(52) U.S. Cl. CPC G06K 9/00798; G06K 9/2027; G06K 9/4604; H04N 5/2256; H04N 7/183; G06K 9/4661

(57) ABSTRACT

A method for pattern detection, classification and tracking is provided herein. The method may include: illuminating a scene according to specified illumination parameters; capturing image frames of the scene by exposing a capturing device, wherein the exposures are synchronized with reflections originated by the illuminating, according to specified synchronization parameters; obtaining one or more pattern to be detected; and detecting the one or more pattern to be detected in the captured images, based on a database of a plurality of patterns, wherein the specified illumination parameters and the specified synchronization parameters are selected such that the at least one pattern to be detected is more detectable at the captured image frames.

### FIELD OF THE INVENTION

The present invention relates to imaging systems, in general, and in particular to method for pattern detection, pattern classification and for tracking objects.

### BACKGROUND OF THE INVENTION

The detection of patterns, classification of patterns and object tracking is important for various markets among them: transportation, automotive, defense, security, consumer and various applications.

For example an automotive application such as Lane Departure Warning (LDW) consists of several steps; lane marking detection, lane marking classification (i.e. different types of lane markings; dashed, single line, two lines, different colors, etc.) detection, lane marking tracking and warning signal in case of deviation from the edge of the lane. Lane Keeping Support (LKS) is another automotive application where lane markings are detected, tracked and latter also prevents the vehicle to deviate from the edge of the lane by continuous steering, braking and/or any other intervention. Forward Collision Warning (FCW) is another automotive application where an alert is provided as a function of Time-To-Contact (TTC) from detected objects (such as: car, bicycle, motorcycle or any other type of object). Driver Assistance Systems (DAS) image based functions (for example: LDW, LKS, FCW etc.) require a reflected light signal originating from at least one of the following: sun spectral irradiance, vehicle forward illumination or ambient light sources. Prior art does not provide an adequate solution to scenarios where tar seams on the road are detected as lane markings and latter mistakenly tracked. In addition, prior art does not provide an adequate solution to scenarios where the lanes marking have low contrast signature in the visible spectrum.

Before describing the invention method, the following definitions are put forward.

The terms “pattern” and/or “patterns” are defined as data type or combination of data types which resemble and/or correlate and/or have certain similarities with system pattern database. Pattern maybe a random data type and/or a constant data type as related to the time domain and/or as related to the space domain. Pattern maybe detected in a certain Region-Of-Interest (ROI) of captured image or maybe detected in the entire captured image FOV.

The term “Visible” as used herein is a part of the electro-magnetic optical spectrum with wavelength between 400 to 700 nanometers.

The term “Infra-Red” (IR) as used herein is a part of the Infra-Red spectrum with wavelength between 700 nanometers to 1 mm.

The term “Near Infra-Red” (NIR) as used herein is a part of the Infra-Red spectrum with wavelength between 700 to 1400 nanometers.

The term “Short Wave Infra-Red” (SWIR) as used herein is a part of the Infra-Red spectrum with wavelength between 1400 to 3000 nanometers.

The term “Field Of View” (FOV) as used herein is the angular extent of a given scene, delineated by the angle of a three dimensional cone that is imaged onto an image sensor of a camera, the camera being the vertex of the three dimensional cone. The FOV of a camera at particular distances is determined by the focal length of the lens and the active image sensor dimensions.

The term “Field Of Illumination” (FOI) as used herein is the angular extent of a given scene, delineated by the angle of a three dimensional cone that is illuminated from an illuminator (e.g. LED, LASER, flash lamp, ultrasound transducer, etc.), the illuminator being the vertex of the three dimensional cone. The FOI of an illuminator at particular distances is determined by the focal length of the lens and the illuminator illuminating surface dimensions.

The term “Depth Of Field” (DOF) as used herein is certain volume of a given scene, delineated by the camera FOV, light source illumination pattern and by a camera/light source synchronization scheme.

### SUMMARY OF THE INVENTION

In accordance with the disclosed technique, there is thus provided an imaging system and a method for pattern detection, pattern classification and a method for tracking patterns which corresponds to different objects or marks in the dynamic scene.

For automotive application such as DAS image based, patterns may be considered as: lane marking, curb marking or any other repeated marks on the road or on the surrounding of the road. Additional patterns may be driven from objects on the road or the surrounding of the road such as: road bumps, vehicles, vehicles tail lights, traffic signs, cyclists, pedestrians and pedestrian accessories or any other stationary or moving object or object unique parts in the scene.

In accordance with one embodiment, a method for the detection of patterns and/or objects from an imaging system (capture device and illuminator) attached to a vehicle is provided. The imaging system is configured to capture a forward image in front of the vehicle platform or configured to capture a rear image in back of the vehicle platform or configured to capture a side image in the side of the vehicle platform. An image includes (i.e. fused of or created by) at least one frame with single or multiple exposures captured by the capture device (i.e. camera, imaging device) at intervals controlled by the imaging system.

Pattern data is constructed from one or more data types consisting of: intensity value, intensity value distribution, intensity high/low values, color information (if applicable), polarization information (if applicable) and all of the above as a function of time. Furthermore, data types may include temperature differences of the viewed scenery. The frame values are typically the digital or analog values of the pixels in the imaging device. The systems may use the data types which characterizes the pattern to be detected in order to adjust the system control parameters such that the pattern is more detectable. The pattern data which includes different data types may further be analyzed to detect a specific pattern and/or to maintain tracking of a pattern.

In accordance with one embodiment, data type is defined as a detectable emitted signal (i.e. Mid-wavelength infrared and/or Long-wavelength infrared) from the viewed scenery.

In accordance with one embodiment, data type is defined as a detectable reflected signal from glass beads or microspheres.

In accordance with one embodiment, data type is defined as a detectable reflected signal from a retro-reflectors (i.e. prismatic cube corner, circular aperture, triangle aperture, etc.).

In accordance with one embodiment, data type is defined as a detectable reflected signal from a unique part of an object in the scene such as tail lights of a vehicle, the tail lights behave as retro reflectors which may be correlated to other data types such as geometrical shape and size of the vehicle, vehicle speed and headings or other parameters of the object that can increase the validity of the pattern detected.

In accordance with one embodiment, data type is defined as a detectable reflected signal from a diffusive pattern with a detectable contrast. The pattern may be defined by chromaticity and luminance.

In accordance with one embodiment, the image capturing of this device is provided during day-time, night-time and in low visibility conditions (such as: rain, snow, fog, smog etc.).

In accordance with one embodiment, the image capturing of this device maybe provided; in the visible spectrum, in the Near-Infra-Red (NIR), in the Short Wave Infra-Red (SWIR) or any spectral combination (for example: Visible/NIR spectrum is from 400-1400 nm, Visible/NIR/SWIR spectrum is from 400-3000 nm).

In another embodiment, a marking or object detection is executed from pattern recognition and/or tracking derived out of at least a single frame (out of the sequences of frames creating an image). Furthermore, an image may be created from sequences of data types frames.

In another embodiment, adjusting the system control parameters enables pattern and/or patterns to be more detectable in data type frame or frames.

In another embodiment, a lane marking/object detection & classification is executed with additional information layers such as originating out of: mobile phone data, GPS location, map information, Vehicle-to-Vehicle (V2V) communication and Vehicle-to-Infrastructure (V2I) communication. For example map information may help in distinguishing between a reflected light originating from pedestrian or traffic signal

According to another embodiment of the invention, each detected lane marking/object is subjected to the tracking process depending on predefined tracking parameters. As a result of the proposed method, “false patterns” such as road cracks (in asphalt, in concrete, etc.), crash barriers, tar seams may be excluded from tracking, which leads to greater robustness of the system.

The image capturing of this device and the techniques described hereinbefore and hereinafter of the present invention are suitable for applications in: maritime, automotive, security, consumer digital systems, mobile phones, and industrial machine vision, as well as other markets and/or applications.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1 is a schematic illustration of the operation of an imaging system, constructed and operative in accordance with some embodiments of the present invention;

FIG. 2A-FIG. 2B are schematic illustrations of a retro-reflectors in accordance with some embodiments of the present invention;

FIGS. 3 is an image taken with a system in accordance with some embodiments of the present invention;

FIG. 4A-FIG. 4C are different data types in accordance with some embodiments of the present invention;

FIG. 5 is a schematic illustration of the operation of an imaging system, constructed and operative in accordance with some embodiments of the present invention;

FIG. 6 is a schematic illustration of an object pattern in accordance with some embodiments of the present invention; and

FIG. 7 describes a flow chart of an embodiment of pattern detection and tracking in accordance with some embodiments of the present invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In accordance with the present invention, the disclosed technique provides methods and systems for imaging, pattern detection, pattern classification and tracking objects.

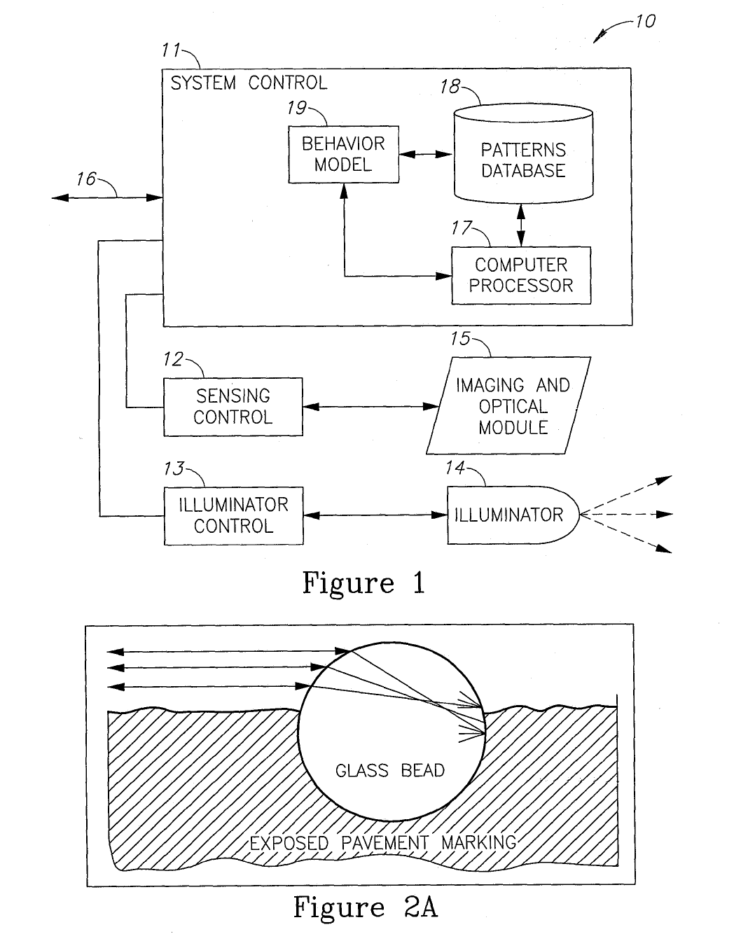

FIG. 1 is a schematic illustration of the operation of an imaging system 10, constructed and operative in accordance with some embodiments of the present invention. System 10 which may include at least a single illuminator 14 that may operate in the non-visible spectrum (e.g. NIR or SWIR by a LED and/or laser source) and/or in the visible spectrum in order to illuminate, for example, the environment. Furthermore, system 10 may also include at least a single imaging and optical module 15. System 10 may further include a computer processor 17, behavior model 19 and a patterns database 18.

Patterns database 18 may include a database of appearances being different “looks” of each of the patterns. Patterns database 18 may be associated with locations and be configured as an adaptive database for context, real-time, temporal, spatial. Additionally, the database may be updated upon demand for example when performance needs to be improved. Additionally, patterns database 18 may be shared between users—to increase reliability of the pattern recognition.

For some applications, imaging and optical module 15 may be attached to the platform or located internally in the platform behind a protective material (e.g. glass window, plastic window etc.). Imaging and optical module 15 may consist a 1D or a 2D sensor array with the ability to provide an image. Furthermore, 1D or a 2D sensor array may be triggered externally per photo-sensing element exposure. Various imaging technologies are applicable in imaging and optical module 15 such as: intensified-CCD, intensified-CMOS (where the CCD/CMOS is coupled to an image intensifier), electron multiplying CCD, electron bombarded CMOS, hybrid FPA (CCD or CMOS where the camera has two main components; Read-Out Integrated Circuits and an imaging substrate), avalanche photo-diode FPA etc. Preferably, optical module 15 includes a Complementary Metal Oxide Semiconductor (CMOS) Imager Sensor (CIS). Optical module within 16 is adapted to operate and detect electromagnetic wavelengths at least those provided by illuminator 14 and may also detect electromagnetic wavelengths of the visible spectrum and of the IR spectrum. Optical module within 15 is further adapted for focusing incoming light onto light sensitive area of sensor array within 15. Optical module within 15 may be adapted for filtering certain wavelength spectrums, as may be performed by a band pass filter and/or adapted to filter various light polarizations. Optical module within 15 is adapted to operate and detect electromagnetic wavelengths similar to those detected by sensor array within 15. The system may provide additional wavelength spectrum information of the scene such as; Mid-wavelength infrared and/or Long-wavelength infrared by additional sensing elements.

According to some embodiments of the present invention, patterns database 18 may also be updated using data derived from external third party sources other than the system of the present invention. These third party sources may include other vehicles (which may be also equipped with a system of the present invention), and Geographic Information System (GIS) maps having data indicative of objects that may be associated with patterns of the predetermined groups. Alternatively, the third party sources may be internal to the vehicle and may include the user who can identify himself objects which are associated with patterns of the predefined group and enter the derive pattern to the database. Alternatively, the third party sources may be internal to the vehicle and may include the mobile hand held devices (i.e. mobile phone, tablet, warble device etc.) which provide information to patterns database 18.

According to some embodiments of the present invention, there is also provided a mathematical model 19 that may be employed in order to predict a behavior of a known pattern type in specific road conditions. Model 19 enables to detect a pattern in an image that either has only part of the pattern or a distorted pattern. The model further enables to make an educated guess as to the location of objects that are not yet viewed by the user. For example, once a continuous line is detected as such, data relating to the behavior of a pattern of a continuous line can be checked versus tempo-spatial data such as the speed of the vehicle, the lighting conditions (as a function of the hour or as a function of the imaging device) and the curvature of the road.

All these parameters are used by the model in order to provide a better prediction of the pattern and hence the object of interest (e.g., the continuous line). According to some embodiments of the present invention, the database can also be provided with a “road memory” feature according to which, the system will be able to recognize a specific road as one that has already been traveled by and so at least some of the objects of interest in this road have already been analyzed in view of their patterns. Thus once another visit to this road is made, all the data associated with the already analyzed patters is readily available. According to some embodiments of the present invention, the database can also be provided with a “road memory” feature according to which, the system will be able to recognize a specific road as one that a different vehicle with system 10 has already been traveled by and so at least some of the objects of interest in this road have already been analyzed.

The objects of interest, each associated with one or more predefined groups of patterns which are a unique pattern signature but also other non-patterns parameters. The combination of pattern type plus non-pattern parameters facilitate the analysis of the data and enable a better recognition, tracking and prediction of the objects of interest in the road and nearby. For example, vehicles may have similar pattern but different dimension, speed and the like. Similarly, pedestrians may have a similar pattern but different speed of walking behavior.

The analysis of the image may take into account, in addition to the recognized patterns of the objects of interest, capturing parameters that are not related to the content of the images but rather to the type of image, capturing device parameters, ambient parameters.

System control parameters as mentioned hereinabove or hereinafter may include at least a specific combination of the following: imaging and optical module 15 parameters (capturing parameters), illuminator 14 parameters (illumination parameters) and external data (via connection feed 16) as described above. System control parameters are tuned (i.e. updated, modified, changed) to make a pattern and/or patterns more detectable in data types.

Imaging and optical module 15 parameters (capturing parameters) may include at least one of: exposure scheme of the sensing elements, gain of the sensing elements, spectral information of the accumulated signal of the sensing elements, intensity information of the accumulated signal of the sensing elements, polarization of the accumulated signal of the sensing elements, field of view and depth-of-field. These capturing parameters may be applicable to the entire sensing elements (e.g. 1D, 2D array) or applicable to a partial part of the sensing elements (i.e. sub array).

System 10 may include at least a single illuminator 14 providing a Field Of Illumination (FOI) covering a certain part of the imaging and optical module 15 FOV. Illuminator 14 may be a Continues Wave (CW) light source or a pulsed light source. Illuminator 14 may provide a polarized spectrum of light and/or a diffusive light.

Illuminator 14 parameters (illumination parameters) comprise at least one of: illumination scheme, amplitude of the illumination pattern, phase of illumination pattern, illumination spectrum and field-of illumination pattern.

System 10 further includes a system control 11 which may provide the synchronization of the imaging and optical module 15 to the illuminator 14. System control 11 may further provide real-time image processing (computer vision) such as driver assistance features (e.g. pattern recognition, pedestrian detection, lane departure warning, traffic sign recognition, etc.). System control 11 may further include interface with platform via 16. Sensing control 12 manages the imaging and optical module 15 such as: image acquisition (i.e. readout), imaging sensor exposure control/mechanism. Illuminator control 13 manages the illuminator 14 such as: ON/OFF, light source optical intensity level and pulse triggering for a pulsed light source configuration.

System control 11 comprises at least one of: synchronization of imaging and optical module 15 with illuminator 14 and external data (via connection feed 16) which may include: location (GPS or other method), weather conditions, other sensing/imaging information (V2V communication and V2I communication), previous detection and/or tracking information.

System 10 may provide images (“data types”) at day-time, night-time & harsh weather conditions based on an exposure mechanism of imaging and optical module 15 exploiting ambient light (i.e. not originating from system 10).

System 10 may provide Depth-Of-Field (DOF) images (“data types”) at day-time, night-time & harsh weather conditions based on repetitive pulse/exposure mechanism of illuminator 14 synchronization to imaging and optical module 15.

System 10 may provide 3D point cloud map (“data type”) at day-time, night-time and harsh weather conditions based on repetitive pulse/exposure mechanism of illuminator 14 synchronization to imaging and optical module 15.

Retro-reflectivity, or retro-reflection, is an electromagnetic phenomenon in which reflected electromagnetic waves are preferentially returned in directions close to the opposite of the direction from which came. This property is maintained over wide variations of the direction of the incident waves. Retro-reflection can be in the optical spectrum, radio spectrum or any other electromagnetic field.

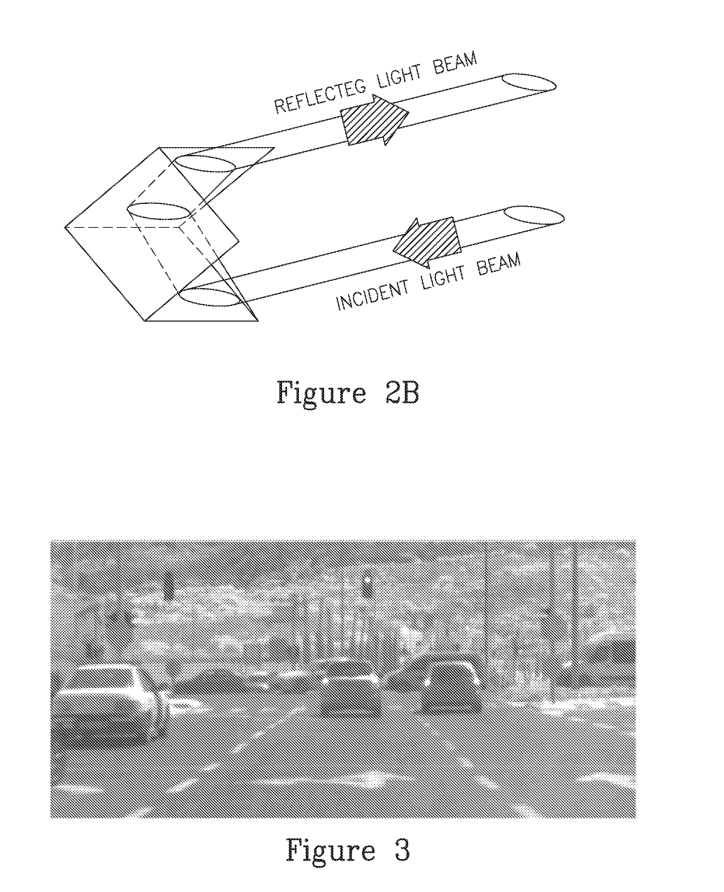

Traffic signs, vehicle license plate, lane markers and curb marking may consist special kinds of paints and materials that provide retro-reflection optical phenomenon. Most retro-reflective paints and other pavement marking materials contain a large order of glass beads per area. In accordance with one embodiment, data type is defined as a frame out of a sequence of frames captured by system 10, where reflected signal from glass beads or microspheres embedded in the paints are detected (as illustrated in FIG. 2A) is detectable.

Traffic signs, vehicle license plate, vehicle rear retro-reflectors, lane markers may be at least a part made of a retro-reflectors such as a prismatic cube corner, a circular aperture, a triangle etc. In accordance with one embodiment, data type is defined as a frame out of a sequence of frames captured by system 10, where reflected signal from retro-reflectors (i.e. prismatic cube corner, circular aperture, triangle etc. (as illustrated in FIG. 2B) is detectable.

In accordance with one embodiment, data type is defined as a frame out of a sequence of frames captured by system 10, where reflected signal from a Raised Pavement Markers (RPMs) retro-reflector is detectable.

In accordance with one embodiment, data type is defined as a frame out of a sequence of frames captured by system 10, where reflected signal from an array of tiny cube corner retro-reflectors is detectable. These arrays can be formed into large sheets with different distribution pattern which are typically used in traffic signs.

In accordance with one embodiment, a frame (data type), out of the sequences of frames captured by the system 10, may consist a detectable reflected gray scale signal from a diffusive pattern with a detectable contrast. Diffusive pattern (i.e. reflection of signal from a surface such that an incident wave is reflected at many angles rather than at just one angle) reflection is common in living creatures, flora or other static objects (e.g. paint, cloth, snow grooves etc.).

In accordance with one embodiment, a captured frame (data type), out of the sequences of frames captured by the system 10, may consist a detectable reflected color signal from a pattern with a detectable contrast and a detectable color spectrum.

In accordance with one embodiment, a captured frame (data type), out of the sequences of frames captured by the system 10, may consist a detectable signal which is originated by an ambient source (i.e. not part of system 10). Ambient source can be considered as: artificial light source (e.g. LEDs, lasers, discharge lamps etc.) or natural light source (sunlight, moonlight, starlight etc.). Ambient light information may also be used to reduce noise and/or adjust system detection performance and/or for detection solely on this external light source.

According to another embodiment, from the information of at least a single frame (e.g. with a specific data type) out of the sequence of frames captured by system 10, at least one pattern data (predefined tracking parameters) is determined Pattern data may consist: intensity value, intensity value distribution, intensity high/low values, color information (if applicable), polarization information (if applicable), fixed/random form and all of the above as a function of time. The frame values are typically the digital or analog values of the pixels in the imaging device 15. The pattern data may further be analyzed by computer processor 17 using patterns database 18, to obtain a detection pattern for tracking.

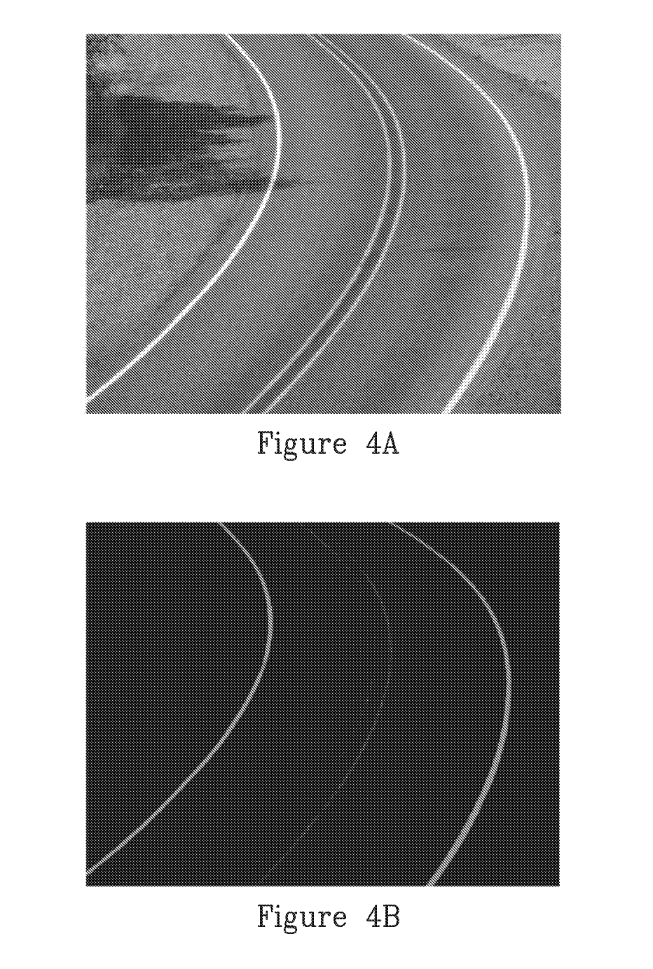

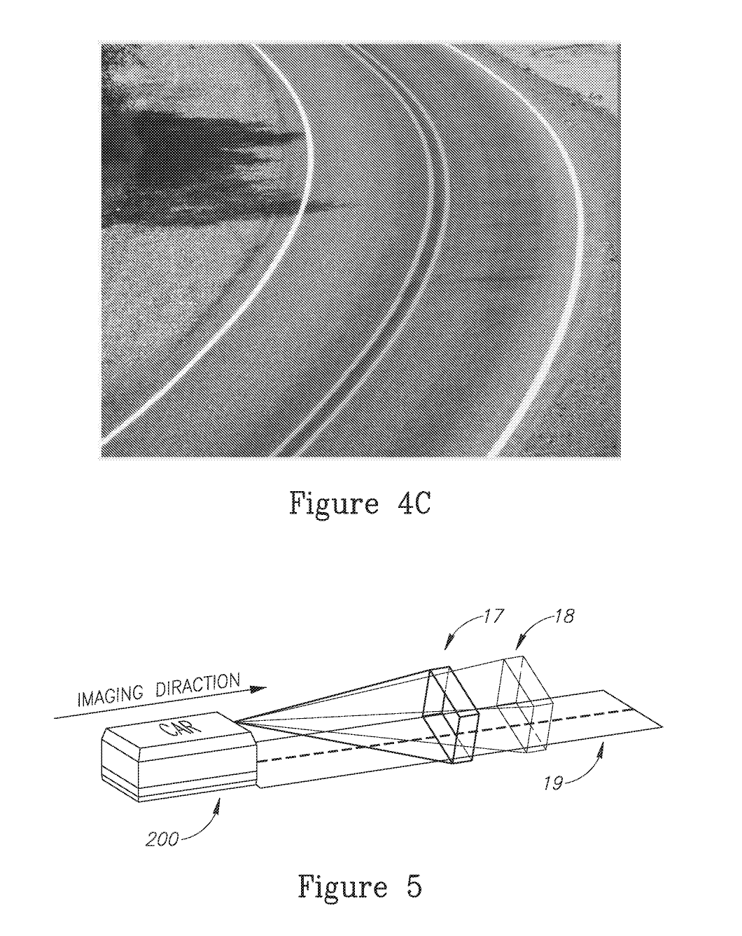

In order to better understand the proposed method and system, FIG. 4A-FIG. 4C illustrates different data types in accordance with some embodiments described hereinabove and hereinafter. FIG. 4A illustrates an asphalt road with lane markings. The external markings are white where the central lines are yellow. System 10 may capture such an image (FIG. 4A) which contain diffusive pattern information (signal) and also color information (signal). FIG. 4B illustrates the same scenario as FIG. 4A, an asphalt road with lane markings The external markings, the central lines and all other features of the image are in gray scale. System 10 may capture such an image (FIG. 4B) which contains diffusive pattern information (i.e. a contrasted intensity mapping). This captured data type (frame) can be the same image as illustrated in

FIG. 4A or a consecutive image (frame) where system 10 may operate in different system control parameters. FIG. 4C illustrates the same scenario as FIG. 4A and FIG. 4B. System 10 may capture different data type (FIG. 4C) containing retro-reflectors pattern information originating from the marking (i.e. retro-reflective paint and/or glass beads and/or RPMs and/or other types of retro-reflectors). This captured data types can be within a single image as illustrated in FIG. 4A/FIG. 4B or a within consecutive images (frames) where system 10 may operate in different system control parameters.

System 10 may fuse the different captured data types (frames) as illustrated in FIG. 4A-FIG. 4C. Fusion process extracts different layers of information from each captured image (frame) to provide a robust, dynamic pattern detection method. Once pattern detection was provided an object tracking method may be added.

FIG. 5 is a schematic illustration of a motor vehicle 200 with system 10. Motor vehicle 200 is driven in a path 19 which may be with marking and or other patterns. System 10 may provide at least a single image (frame) out of the sequence of frames where a DOF is provided. In this illustration two different DOFs are illustrated (17, 18). This method can provide image enhancement capabilities and/or range information (based on system timing scheme) to different objects (or patterns).

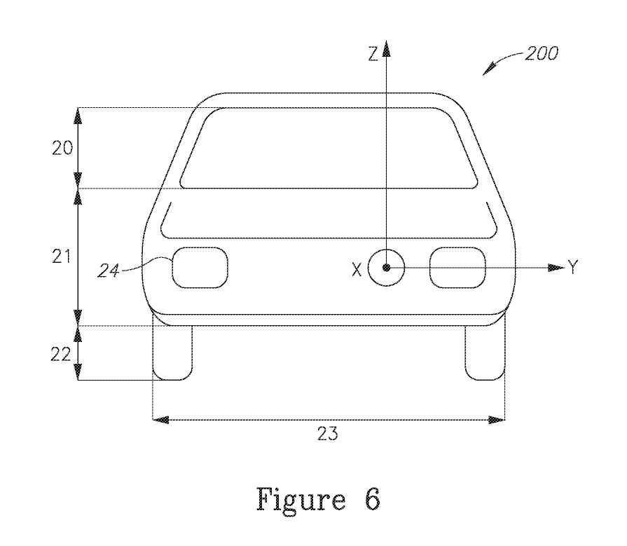

FIG. 6 is a schematic illustration of an object pattern, a rear motor vehicle 200, in accordance with some embodiments of the present invention. This pattern is typically imaged by forward vision systems for automotive application. A motor vehicle 200 may be imaged by system 10 in different system control parameters where diffusive data may be applicable in some frames and/or retro-reflection data may be applicable in other frames. Each area of the motor vehicle 200 (area 1: shape bounded by 22 and 23, area 2: shape bounded by 21 and 23 and area 3: shape bounded by 20 and 23) reflect signal differently as to system 10.

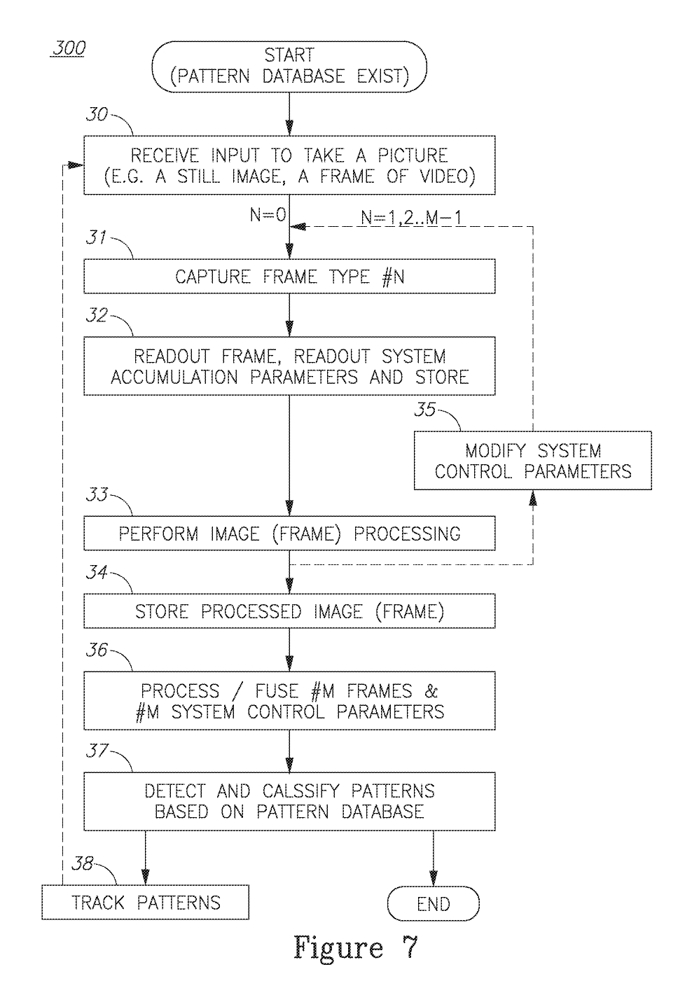

FIG. 7 describes flow chart of an embodiment of pattern detection and tracking by system 10 in accordance with some embodiments of the present invention. In the preliminary stage (Start) a pattern database is defined. This stage maybe “offline” (i.e. prior operation) or during operational. The pattern database was defined hereinabove. The process is initiated where at least a single picture is taken 30. A single first frame (31, N=0) is captured with specific system 10 control parameters (as defined hereinabove). In the next step 32, a frame is readout from the image sensor (within imaging and optical module 15) and system 10 control parameters are also monitored and stored. Based on this stored data an initial image processing step takes place 33. The output of this step may be an initial pattern detection (based on predefined tracking parameters in pattern database as described hereinabove) and/or system updated system control parameters which may be used in the consecutive frame (N=1).

Step 34 stores the processed image (frame, N=0) with initial pattern detection (if applicable). An additional frame may be captured with system 10 control parameters 35. Steps 31-34 are repeated for (M−1) numbers of frames (that may be similar type or that may be different in type). Platform (e.g. vehicular, hand held etc.) which system 10 is attached to may move or be static during steps 31-35. A movement of platform may update system 10 control parameters.

In step 36, M processed and stored different frames coupled with M different system 10 control parameters are processed, fused to provide a detection pattern in step 37. Once a pattern is valid (i.e. compared to pattern database and passes a certain threshold) in step 37, classified to a certain type of pattern, process flow may continue (step 38) where detection/classification pattern features are provided to platform via 16. In parallel , step 38 further more initiates an additional set of new frames, hence step 30. In case step 37 outputs are not applicable (e.g. not valid or have not passed a threshold), hence no pattern detection and/or no pattern classification the flow process ends.

Illuminator 14 parameters (illumination parameters) and illuminator control 13 parameters may comprise at least one of: illuminator amplitude of the pulse, duration of the pulse, frequency of the pulses, shape of the pulse, phase of the pulse, spectrum of the illumination and duty cycle of the pulses.

Imaging and optical module 15 and sensing control 12 parameters may comprise at least one of: gain, duration of the exposure, frequency of the exposures, raise/fall time of the exposure, polarization of the accumulated pulse, and duty cycle of the exposures. These parameters may be applicable to the entire Imaging and optical module 15 or applicable to parts of the Imaging and optical module 15.

System control 11 parameters may comprise on a synchronization scheme of illuminator 14 to imaging and optical module 15.

In another embodiment, system 10 may consist at least two imaging and optical modules 15 with different Line-Of-Sight (LOS) and with known distance from each other, providing the same frame type or different frame types for improving pattern recognition, object classification and tracking.

According to some embodiments of the present invention, patterns database 18 may first be generated during a training process in which similar patterns are grouped together based on predetermined criteria. Then, database 18 can be constantly updated as new patterns are being identified by the system and classified into one of the plurality of predetermined groups.

While the aforementioned description refers to the automotive domain, it is understood that the reference to the vehicles and road environment is none limiting by nature and for illustration purposed only. The pattern oriented gated imaging image processing capabilities of embodiments of the present invention may also be applicable to other domains such as marine environment, homeland security surveillance, and medical imaging.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A method comprising:
obtaining one or more pattern to be detected;
illuminating a scene according to specified illumination parameters;
capturing at least one image frame of the scene according to specified capturing parameters by exposing a capturing device, wherein at least one exposure is synchronized with reflections originated by the illuminating, according to specified system control parameters; and
detecting the one or more patterns to be detected in the at least one captured image, based on a database of a plurality of patterns,
wherein at least one of: the specified illumination parameters, the specified capturing parameters, and the specified system control parameters are selected such that the at least one pattern to be detected is more detectable in the at least one captured image frame.

2. The method according to claim 1, wherein the detecting is carried out by applying a classifier on a database containing a plurality of various appearances of each of the patterns, wherein an appearance relate to a modified version of the patterns.

3. The method according to claim 1, wherein the specified illumination parameters comprise at least one of: illumination scheme, amplitude of the illumination pattern, phase of illumination pattern, illumination spectrum, and field-of illumination pattern.

4. The method according to claim 1, wherein the specified capturing parameters associated with sensing elements comprise at least one of: exposure scheme of the sensing elements, gain of the sensing elements, spectral information of the accumulated signal of the sensing elements, intensity information of the accumulated signal of the sensing elements, polarization of the accumulated signal of the sensing elements, field of view, and depth-of-field.

5. The method according to claim 1, wherein the specified system control parameters comprise at least a specific combination of: illumination parameters, capturing parameters, and external data.

6. The method according to claim 1, wherein the at least one pattern to be detected is associated with one or more data types and wherein the method further comprising selecting the specified illumination parameters, the specified capturing parameters, and the specified system control parameters such that the at least one data type associated with the at least one pattern to be detected, becomes more detectable.

7. The method according to claim 6, wherein the at least one data type comprises least one of: intensity value, intensity value distribution, intensity high/low values, color information, and polarization information.

8. The method according to claim 1, wherein the capturing is repeated several times, each time for a different pattern to be detected, with different illumination parameters and synchronization parameters that are selected in accordance with the pattern to be detected for each repetition.

9. The method according to claim 8, wherein the repeated capturing is fused into a single frame with the plurality of patterns being distinguishable over non patterned portions.

10. The method according to claim 1, wherein the patterns are at least one of: lane markings, curb marking, and any other marking on the road.

11. The method according to claim 1, wherein the patterns are at least one of: diffusive, specular, and retro-reflective.

12. A system comprising:
a computer processor configured to obtain one or more pattern to be detected;
an illuminator configured to illuminate a scene according to specified illumination parameters;
a capturing device configured to capture at least one image frame of the scene according to specified capturing parameters by exposing a capturing device, wherein at least one exposure is synchronized with reflections originated by the illuminating, according to specified system control parameters; and
a database configured to store a plurality of patterns,
wherein the computer processor is further configured to detect the one or more patterns to be detected in the at least one captured image, based on the database, and
wherein at least one of: the specified illumination parameters, the specified capturing parameters, and the specified system control parameters are selected such that the at least one pattern to be detected is more detectable in the at least one captured image frame.

13. The system according to claim 12, wherein the detecting is carried out by applying a classifier on the database containing a plurality of various appearances of each of the patterns, wherein an appearance relate to a modified version of the patterns.

14. The system according to claim 12, wherein the specified illumination parameters comprise at least one of: illumination scheme, amplitude of the illumination pattern, phase of illumination pattern, illumination spectrum, and field-of illumination pattern.

15. The system according to claim 12, wherein the specified capturing parameters associated with sensing elements comprise at least one of: exposure scheme of the sensing elements, gain of the sensing elements, spectral information of the accumulated signal of the sensing elements, intensity information of the accumulated signal of the sensing elements, polarization of the accumulated signal of the sensing elements, field of view, and depth-of-field.

16. The system according to claim 12, wherein the specified system control parameters comprise at least a specific combination of: illumination parameters, capturing parameters, and external data.

17. The system according to claim 12, wherein the at least one pattern to be detected is associated with one or more data types and wherein the method further comprising selecting the specified illumination parameters, the specified capturing parameters, and the specified system control parameters such that the at least one data type associated with the at least one pattern to be detected, becomes more detectable.

18. The system according to claim 17, wherein the at least one data type comprises least one of: intensity value, intensity value distribution, intensity high/low values, color information, and polarization information.

19. The system according to claim 12, wherein the capturing is repeated several times, each time for a different pattern to be detected, with different illumination parameters and synchronization parameters that are selected in accordance with the pattern to be detected for each repetition.

20. The system according to claim 19, wherein the repeated capturing is fused into a single frame with the plurality of patterns being distinguishable over non patterned portions.

21. The method according to claim system according to claim 12, wherein the patterns are at least one of: lane markings, curb marking, and any other marking on the road.

22. The method according to claim system according to claim 12, wherein the patterns are at least one of: diffusive, specular, and retro-reflective.
